(19) United States
(12) Patent Application Publication
(10) Pub. No.: US 2005/0180484 A1
(43) Pub. Date: Aug. 18, 2005

(54) Active optical coupling element

(75) Inventor: Engin Molva, Grenoble (FR)

Correspondence Address: PILLSBURY WINTHROP SHAW PITTMAN, LLP, P.O. BOX 10500, MCLEAN, VA, 22102, US

(73) Assignee: TEEM PHOTONICS, 38240 Meylan (FR)

(21) Appl. No.: 10/481,450

(22) PCT Filed: Jun. 19, 2002
(86) PCT No.: PCT/FR02/02122

(30) Foreign Application Priority Data
Jun. 21, 2001 (FR) 01/08220

(51) Int. Cl. H01S 3/091

(52) U.S. Cl. 372/70

(57) ABSTRACT

An active coupling device enabling a light signal to be coupled to an optical component having a waveguide. The light signal has a first range of wavelengths. The active coupling device is configured to receive the light signal and to emit a light wave in a second range of wavelengths. The optical component comprises at least one input waveguide associated with a third range of wavelengths. The second range of wavelengths lies at least in part in the third range of wavelengths. The Active coupling device can be incorporated in an optical structure and can be useful in the fabrication of a structure including an optical component such as an optical amplifier, spectrum inverter or frequency converter.

### CROSS-REFERENCE TO RELATED APPLICATIONS

This application is based on and claims priority to application Ser. No. 01/08220 Jun. 21, 2001 and application No. PCT/FR02/02122 filed Jun. 19, 2002 in France, the entire contents of each of which are hereby incorporated by reference.

### BACKGROUND OF THE INVENTION

1. Field of the Invention

The present invention relates to an active coupler enabling a light signal to be coupled to an optical component with a waveguide, and an optical structure using the coupler. For example, the active coupler allows coupling light signals to a waveguide such as a planar guide or an optical fiber.

2. Description of Related Art

At the present time, there are two possibilities to introduce a light signal into a waveguide of a component: one possibility is by direct coupling; another possibility is by coupling via a passive device.

Direct coupling consists of directly coupling the light signal, emitted from a light source, for example, a laser or a laser diode, into the input guide of the component, without the use of a coupling device.

Coupling via a passive device consists of inserting the device between the source and the input guide of the component. The passive coupling device may be an optical collimator, for example (consisting of a lens or set of lenses able to focus the optical beam of the source in the waveguide of the component) or an optical fibre (enabling the source to be connected to the waveguide of the component by mechanical means such as ferrules).

FIG. 1 shows an example of a conventional optical structure comprising a coupling device 1, for example a lens. The coupling device 1 allows to couple a light source 3 to an optical component 5 comprising a waveguide. The optical component 5 is for example an optical amplifier.

In this example, the optical amplifier comprises 2 input waveguides 7 and 9 of a microguide type which converge in an output waveguide 11 also of a microguide type.

Therefore, source 3 is optically connected to coupling device 1, which in turn is optically connected to the input of waveguide 7. In addition, a component 13 emitting an optical signal 15 to be amplified by the amplifier 5 is optically connected to the input of waveguide 9.

Therefore, signal 15 is amplified in amplifier 5 by the light wave emitted from pumping source 3 and is coupled in guide 7 via coupler 1 and mixed with signal 15 in guide 11. The amplified optical signal 17 then leaves the amplifier via output guide 11. Light source 3 constitutes an energy source for the amplifier.

For simplification purposes, in this figure and the in the remainder of the description, only the core of the guides is shown.

Although satisfactory in some respects, direct coupling, or coupling via a passive device, of a light signal to an optical component having a waveguide has a certain number of limitations.

These limitations are due to adaptation problems of the light signal entering the optical component, which do not allow efficient transfer of signal light power to the component.

To allow such adaptation, firstly the optical signal wavelength spectrum is adapted to the wavelength spectrum of the component. In particular, when the signal to be coupled corresponds to an energy source for the component, the emission spectrum of the signal should correspond to the spectrum of the component (in particular the absorption spectrum in the case of amplifiers, so that the coupled power is practically entirely absorbed and contributes to supplying the component with energy).

In addition, to allow such adaptation, the spatial mode structure of the signal should be adapted to the input guide of the component to the extent possible to achieve efficient coupling. In other words, the greatest part of the signal light wave should be coupled in the guide.

Concerning adaptation of the signal's spectrum, current components especially in telecommunications, such as components requiring a light energy source, e.g. amplifiers (which generally have a spectrum in the spectral bands of the order of 1550 nm, typically between 1528 and 1620 nm and more generally between 1200 and 1700 nm) are pumped at wavelengths in which a large part is inaccessible or scarcely accessible by known laser diodes. Therefore, this requires the use of either solid lasers that are cumbersome, voluminous and costly or highly complex lasers.

Furthermore, with regard to spatial mode adaptation, the optical guides of the optical component are generally single-mode or have few modes only. Therefore, whether coupling the signal to the component is made directly or via a passive coupling device, it is essential that this signal should be single-mode or have very high optical beam quality. By high optical beam quality it is meant a beam having few modes, i.e. close to the diffraction limit. These signal constraints prevent the use of high-powered laser diodes as signal sources since this type of sources is multimode (may contain several hundred modes).

### BRIEF SUMMARY OF THE INVENTION

One aspect of an embodiment of the present invention is to provide a coupling device which is active. The device enables coupling of a light signal to an optical component having a waveguide. The device does not have the limitations and difficulties of the above-mentioned structures.

One aspect of an embodiment of the invention is to provide an active coupling device which adapts the light signal wavelength or wavelengths to the spectrum of the optical component. In this way, this allows accessing new wavelength domains required in the development of, for example, Dense Wavelength Division Multiplexing (DWDM) in telecommunications.

Another aspect of an embodiment of the invention is to provide an active coupling device which allows to adapt the spatial mode or modes of the light signal to the mode or few modes of the guide of the component.

A further aspect of an embodiment of the invention is to provide a structure using an active coupler device, coupling a light signal to a component having a waveguide, which is compact, low cost and having improved performance.

An aspect of an embodiment of the invention is to provide an active coupling device allowing to couple a light signal having a first range of wavelengths to an optical component comprising at least one input waveguide associated with a second range of wavelengths. The active coupling device is able to receive the light signal and to emit a light wave in a third range of wavelengths which lies at least in part in said second range.

By range of wavelengths, it is meant a set of one to several wavelengths.

Generally, the second range of wavelengths is greater than the first range of wavelengths.

According to one embodiment of the invention, the coupling device can emit the light wave in a mode profile adapted to the mode profile of the input waveguide.

The mode profile of the input waveguide is generally single-mode or slightly multimode. At all events, the coupling device allows to reduce the number of modes entering the waveguide of the component when the light signal is multimode.

According to an exemplary embodiment of the invention, the active coupling device is formed by a laser cavity and generally comprises a laser material, doped with active ions, inserted between first and a second reflection means (reflectors) such as mirrors. The first reflection means receives the light signal and the second reflection means transmits the light wave. The first reflection means (reflector) is able to transmit the light signal and to reflect the light wave.

According to one embodiment of the invention, the second reflection means (reflector) can also reflect the light signal.

In one exemplary embodiment, at least one of the first or second reflection means is a concave mirror.

In another exemplary embodiment, at least one of the first or second reflection means is a network of micro-mirrors which can be used to obtain a network of laser micro-cavities.

By reflection and/or by transmission, it is meant a substantial reflection and/or transmission, but without being limited to total reflection and/or transmission.

The laser material can be selected from at least one of the following materials or a combination thereof:
oxide materials such as YAG (Y₃Al₅O₁₂) or YVO₄ or YAP (YAlO₃), . . .
fluoride materials such as YLF (YLiF₄) or CaF₂ or LaF₃, . . .
materials containing phosphates, silicates, tungstates, molybdates, vanadates or beryllates;
phosphate or silicate glasses.

The laser material can also be doped with ions which are the active elements enabling emission of the light wave through laser effect. The ions used are chosen from at least one of the following ions or a combination thereof:
rare earths (Nd³⁺, Er³⁺, Ho³⁺, Ce³⁺, Tm³⁺, Pr³⁺, Gd³⁺, Eu³⁺, Yb³⁺, Sm²⁺, DY²⁺, Tm²⁺, . . . );
transition metals (Cr³⁺, Ni²⁺, Co²⁺, Ti³⁺, V²⁺, . . . );
actinides (U³⁺, . . . ).

According to one exemplary embodiment, a laser material is doped or co-doped with rare earth ions. This co-doping improves laser efficiency.

The list of laser materials and dopants cited above is evidently not exhaustive and is only given by way of example. Other examples can be found in the literature of lasers which can be used in the present invention.

According to an embodiment of the invention, the mirrors located either side of the laser material are respectively formed by deposition of dielectric multilayers such as alternate layers of SiO₂ and TiO₂ for example.

A further aspect of an embodiment of the invention is an optical structure comprising:
at least one source, the source emitting the light signal,
an optical component comprising at least one input waveguide, and
at least one active coupling device such as described previously, inserted between the source and the input waveguide.

The optical component may be either a passive component or an active component.

In one embodiment of the invention, the waveguide is taper-shaped at its input to improve adaptation of the light wave to the guided mode profile of the input guide.

According to an embodiment of the invention, the optical structure comprises first collimation means (first collimator) arranged between the source and the coupling device.

According to one embodiment, second collimation means (second collimator) is arranged between the coupling device and the waveguide.

According to another embodiment, the coupling device is arranged directly at the input of the waveguide.

According to a first exemplary embodiment, the source is a pumping source such as a laser diode and the light signal emitted by said source provides optical energy to the component.

According to a second exemplary embodiment, the source is an optical element (such as a modulated laser diode, the output of an amplifier, etc.) and the light signal emitted by the source provides optical data, for example.

The optical component may have other optical inputs optionally receiving other optical signals via an active coupling device, for example.

According to one exemplary embodiment, the structure comprises:
a first source formed by a pumping source which can emit a first light signal,
a second source formed by an optical element which can emit a second light signal,
an optical component comprising at least one first input waveguide and at least one second input waveguide,
a first active coupling device arranged between the first source and the first guide. The first active coupling device is able to receive the first light signal and to emit a first light wave, and
optionally a second active coupling device arranged between the second source and the second guide. The second active coupling device is able to receive the second light signal and to emit a second light wave.

In one exemplary embodiment, the second active coupling device can be used when the optical signal of the second source has power characteristics in which the second active coupling device can use the optical signal to emit a light wave.

In this particular example, the component is an active component which allows the component to interact with the second light signal emitted by the optical element via the light energy contributed by the first light signal from the pumping source.

This active component can be an optical amplifier, a spectrum inverter, an optical frequency converter, etc.

According to another exemplary embodiment, the structure comprises:
a matrix of n×m sources,
an optical component comprising at least n×m input waveguides,
a matrix of n×m active coupling devices arranged between the matrix of sources and the n×m guides,
optionally, a first matrix of n×m collimation means (collimators) between the matrix of sources and the matrix of coupling devices,
optionally a second matrix of n×m collimation means (collimators) between the matrix of coupling devices and the input waveguides.

Other characteristics and aspects of the invention will become more clearly apparent in the following description taken with reference to the figures in the appended drawings.

### BRIEF DESCRIPTION OF THE DRAWINGS

In the accompanying drawings:

FIG. 1 is a schematic showing a conventional coupling between a component of amplifier type and a pumping source;

FIG. 2 is a schematic representation of an active coupling device according to an embodiment of the invention;

FIG. 3 is a schematic showing the principle of a structure using a coupling device according to an embodiment of the invention;

FIG. 4 is a schematic illustration showing the principle of another structure using a coupling device according to an embodiment of the invention;

FIG. 5 is a schematic representation of a structure using a coupling device according to an embodiment of the invention;

FIG. 6 is a schematic representation of a structure using a coupling device applied to a matrix structure according to an embodiment of the invention;

FIG. 7 is a schematic representation of a structure using a coupling device according to an embodiment of the invention; and

FIG. 8 is a schematic representation of a structure using a coupling device, applied to a matrix structure, according to an embodiment of the invention.

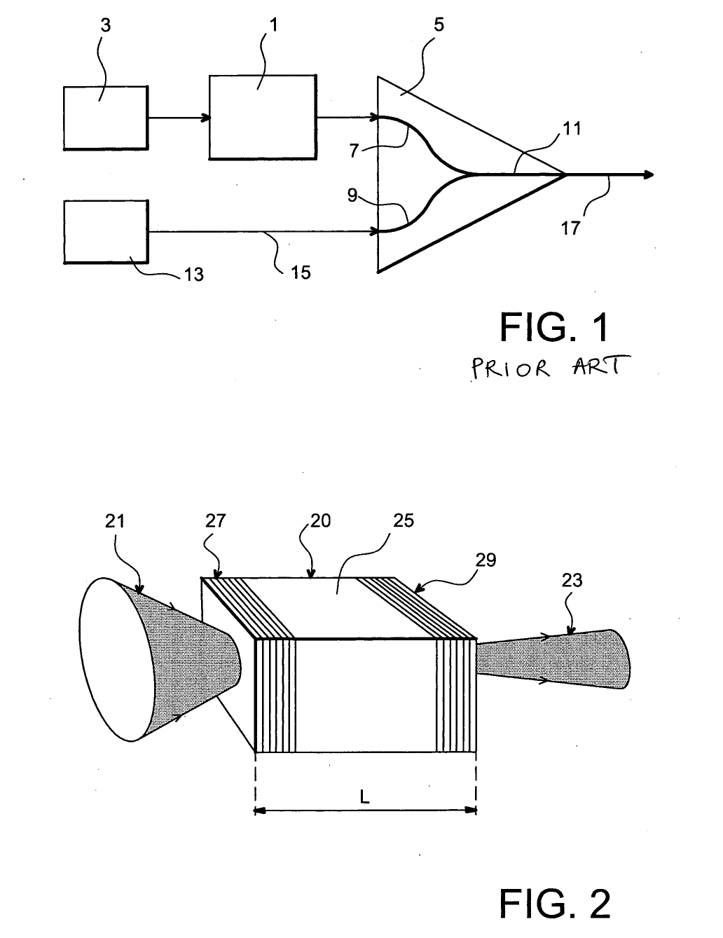

### DETAILED DESCRIPTION OF THE INVENTION

In the following description, optical component means both an all-optical component and an optoelectronic component or in general any component comprising at least one optical input. According to an embodiment of the invention, a component having a waveguide is a component comprising at least one input waveguide. The waveguide possibly being a planar guide, a lateral-confined guide called a microguide or an optic fibre. These optical components may also be fabricated using integrated optics. By way of example III-V-on-InP semiconductor guides can be cited, including lithium niobate guides, silica-on-silicon guides or guides fabricated on glass by ion exchange or layer deposition.

In the present invention any light signal can be coupled to an optical component. The light signal may be a data-carrying signal or light energy source also called optical pump obtained, for example, with a laser or laser diode.

On this respect the invention applies to the optical coupling of numerous components and more particularly to optical components using optical pumping such as optical amplifiers having a waveguide, spectrum invertors or optical frequency converters used for example in optical communications networks such as Dense Wavelength Division Multiplexing (DWDM), and Optical Time division Multiplexing (OTM).

Therefore, the invention finds applications both in the area of optical signal transfer systems and in optical signal processing.

FIG. 2 is a perspective diagram of an active coupling device 20 according to an embodiment of the invention.

As stated previously, with this active coupling device it is possible to receive a light signal 21 having a given range of wavelengths and to couple the light signal 21 to the input of an optical component (not shown) comprising at least one input waveguide associated with another range of wavelengths.

Device 20 can, therefore, receive light signal 21 on an input and emit a light wave 23 over a range of wavelengths falling at least in part in the range which can be used by the waveguide.

If signal 21 is multimode, the coupling device can also transform the signal into a light wave 23 having a mode profile adapted to the mode profile of the input waveguide of the component. This mode profile is generally single-mode or slightly multimode. Therefore, with the coupling device, it is possible to reduce the number of modes entering the waveguide of the component when signal 21 is multimode.

To achieve these operating functions, the active coupling device is selected to be a laser cavity and comprises a laser material 25 doped with active ions. First and second reflection means or reflectors such as mirrors 27, 29 are arranged on two of the walls of the material. In this example, the two walls concerned are walls parallel to one another. Mirror 27 receives light signal 21 and transmits the light signal 21 to laser material 25 and reflects light wave 23 created by the laser cavity. Mirror 29 reflects and transmits, at least in part, light wave 23 and preferably reflects signal 21.

For example, the laser material is a parallelepiped of cross-section 1×1 mm2 with a thickness ranging from 100 μm to 1 mm. The laser material is, for example, phosphate glass doped with rare earth ions such as Er³⁺ or co-doped with rare earth ions such as Er³⁺ and Yb³⁺. The co-doping enables improved laser efficiency.

The ion concentration can be of the type used in known lasers.

In this example, the mirrors are arranged directly on two of the parallel surfaces of the laser material 25. Preferably, the surfaces are previously polished.

According to one embodiment, the mirrors are fabricated by dielectric multilayer deposition. The dielectric multilayers can be formed by vapour deposition or sputtering, using conventional techniques. The multilayers are, for example, alternate layers of SiO₂ and TiO₂ forming an assembly of a few dozen layers (approximately 20 to 30). The total thickness of the SiO₂ and TiO² multilayers is approximately 4 to 6 μm. This example is evidently only given by way of indication. One of ordinary skill in the art would appreciate that other materials can possibly be used to form the mirrors. Furthermore, the thicknesses of these multilayers may be varied and can reach several dozen μm.

The thickness of each layer and the number of layers are selected such that the stack obtained allows achieving appropriate reflectance and transmission spectra for the corresponding mirror.

With a coupling device such as the one described above, a multimode light signal 21 focused on mirror 27 with a diameter of 100 to 150 μm and wavelength λ₁ of approximately 975 nm, can create a single-mode light wave 23 of wavelength λ₂ of approximately 1550 nm, transmitted by mirror 29 with low divergence (approximately 10 mrad).

Input mirror 27 is highly transmissible (approximately >90%) at λ₁ and highly reflectance (approximately >90%) at λ₂.

Output mirror 29 has a transmission of approximately 1 to 20% at λ₂, and has a high reflectance (approximately >90%) at λ₁. In this way, the power of signal 21 which is not absorbed when first passing through the laser material is reflected by mirror 29 and this can be absorbed during subsequent passes in the material.

In this example, mirrors 27, 29 are arranged directly on laser material 25. However, in some cases, one or both mirrors can be fabricated on an initial substrate (glass for example). The mirror or mirrors provided with their respective substrate(s) can then be assembled onto laser material 25, for example, by appropriate bonding or mechanical assembly to place the mirrors in contact with the laser material.

Also, in this examplary embodiment, mirrors 27, 29 are planar mirrors. However, other types of mirrors may be used for mirror 27 and/or 29 such as concave mirrors or networks of micro-mirrors.

The use of concave mirrors on at least one of the surfaces (input or output or both) of the laser material allows to obtain an optically stable laser cavity. For this purpose, the concave mirror advantageously has a curvature radius R greater than length L of the cavity. For a value L lying between approximately 0.3 and 1 mm, a value R is chosen between 0.5 and 10 mm and the diameter of the concave mirror is chosen to be greater than approximately 100 μm. The concave mirror may be fabricated using conventional techniques either directly on the surface of the laser material (using photolithography for example and ion etching), or it may be fabricated on another substrate and added by assembly onto the planar surface of the laser material.

The use of a network of micro-mirrors on at least one of the surfaces of the laser material allows to obtain a network of stable, coupled micro-cavities. The use of a network of micro-mirrors increases the overall output power of light wave 23. For example a network of micro-mirrors may be fabricated over the entire surface (e.g.: 1×1 mm²) of the input surface of the laser material. Each micro-mirror can have a diameter between 50 μm and 500 μm, for example 100 μm. The network of micro-mirrors may be made using known technique, either directly on the surface of the laser material (by photolithography for example and ion etching), or it may be made on another substrate and added by assembly onto the planar surface of the laser material.

Wavelength λ₂ of wave 23 emitted by the active coupling device mainly depends upon the choice of dopant, but varies somewhat in relation to the choice of laser material.

Below are some examples of values obtained for λ₂ with different laser materials:
For YAG or YVO₄ laser material or other oxides doped with Nd ions, λ₂ is respectively in the region of 1.06 μm, 0.95 μm, or 1.35 μm.
For YLF laser material doped with Nd ions, λ₂ is in the region of 1.05 μm to 1.3 μm;
For laser material of phosphate or silicate glass type, Er doped or Er and Yb co-doped, λ₂ will be in the region of 1.5 μm and is particularly suitable for the range of wavelengths of components of known amplifier types such as EDFA (Erbium Doped Fiber Amplifier) or EDWA (Erbium Doped Waveguide Amplifier) which use the same active ions and the same materials.

Wavelength λ₂ of the initial signal 21 is chosen, insofar as is possible and especially when this signal derives from a laser source, so that it corresponds to at least in part to the absorption band of the dopant of the laser material.

By way of example:
For a Nd-based laser material, a signal having a wavelength λ₁ of approximately 800 nm is to be chosen.
For an Er-based or Er+Yb-based laser material, a signal having a wavelength λ₁ of approximately 980 nm is chosen.

Laser sources emitting in these ranges are known and commercially available. In addition, this type of source can provide relatively high powers and is available at reduced cost and in compact form. Finally, even though these known sources are generally multimode, the coupling device of the invention can achieve a single-mode or low-multimode wave.

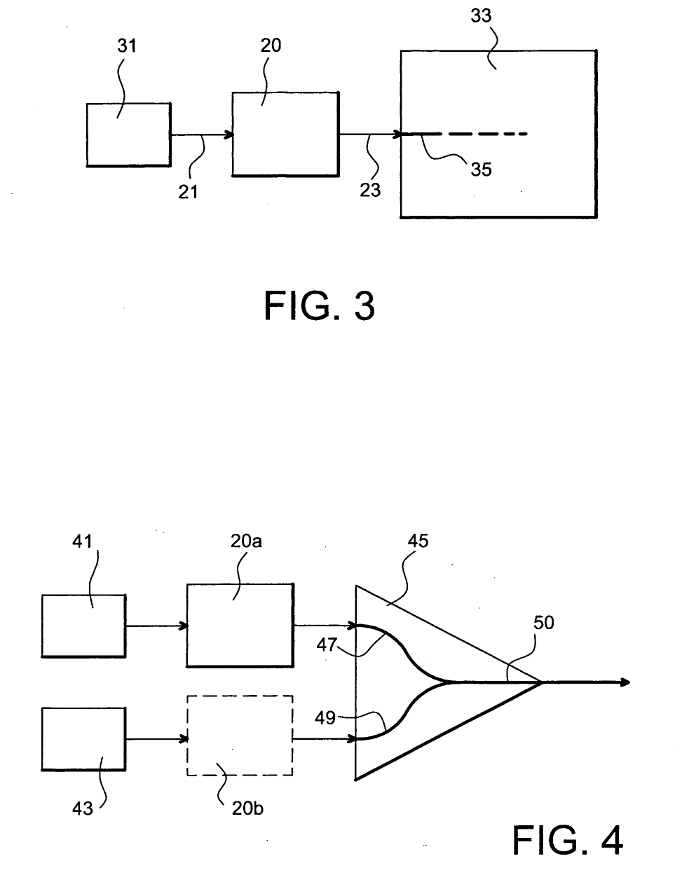

FIG. 3 is a schematic illustration of a basic structure using an active coupling device according to one embodiment of the invention.

This optical structure comprises a source 31 which can emit light signal 21, an optical component 33 comprising at least one input waveguide 35 and an active coupling device 20 such as described previously, inserted between the source an the input waveguide.

The source is either a pumping source such as a laser diode, when light signal 21 emitted by the source provides optical energy for the component, or an optical element (such as a modulated laser diode or an amplifier output) when the light signal emitted by the source provides optical data, for example.

The optical component may be either a passive component or an active component. It may also have other optical inputs (not shown) optionally receiving other optical signals, optionally via an active coupling device according to an embodiment of the invention.

FIG. 4 schematically illustrates another basic structure using one or more active coupling devices according to an embodiment of the invention.

This structure comprises a first light source 41 having a pumping source, a second light source 43 having an optical element which can emit a light signal, an optical component 45 such as an optical amplifier. The optical component 45 comprises a first input waveguide 47 and a second input waveguide 49. In this structure, a first active coupling device 20a is arranged between source 41 and input guide 47, and optionally a second active coupling device 20b is arranged between source 43 and input guide 49.

The second active coupling device can be used when the optical signal of the second source has power characteristics to allow the second active coupling device to use the optical signal to transmit a light wave.

In this particular example, the component is an active component which interacts with the light signal transmitted by the optical element through the light energy provided by the light signal emitted by the pumping source.

This active component may be an optical amplifier, a spectrum inverter, an optical frequency converter, etc.

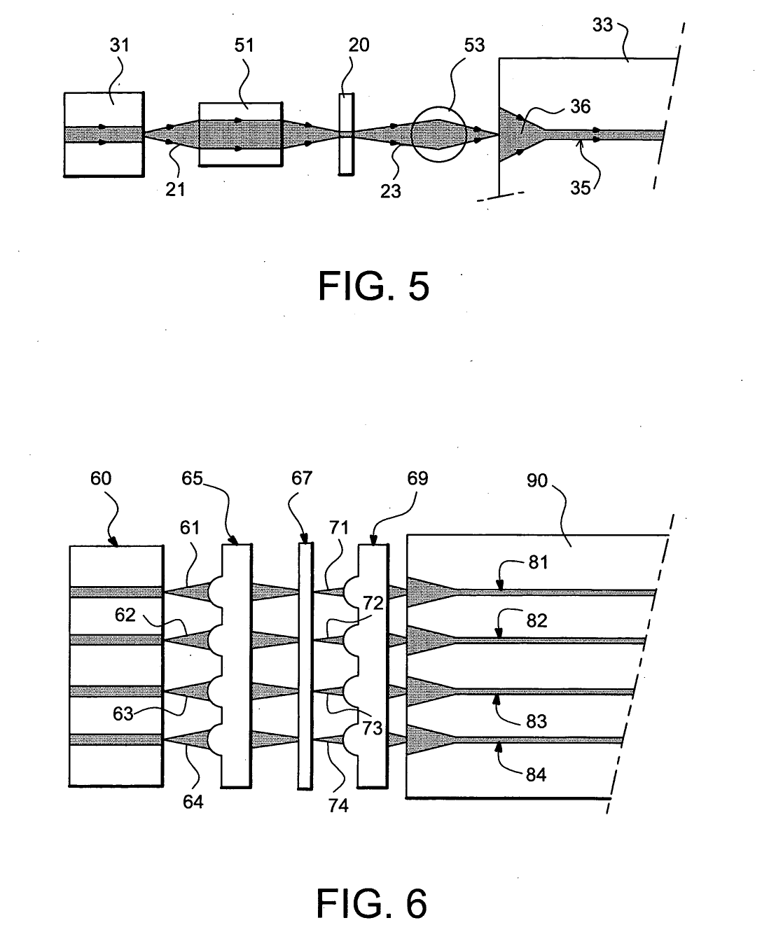

FIG. 5 is a schematic illustration of a first variant of the structure shown schematically in FIG. 3 along a section containing input guide 35. In this figure source 31 is a source of single bar-laser diode type.

In relation to FIG. 3 this structure comprises collimation means (collimator) 51 arranged between source 31 and active coupling device 20 and collimation means (collimator) 53 arranged between the coupling device and waveguide 35.

These collimation means consist of lenses for example and enable focusing of light signal 21 and light wave 23 respectively.

In this figure the waveguide has a tapered input corresponding to a taper 36 to improve adaptation of light wave 23 to the profile of the guided mode or modes of the input guide. However, one of ordinary skill in the art would appreciate that in some cases the light wave arriving at the input of the guide is such that the taper is not necessary. In particular the taper is unnecessary when collimation means 53 is chosen for proper focusing of light wave 23 in input guide 35.

This structure principle can be generalised to a matrix as shown in FIG. 6. To simplify the description, this figure illustrates a unidirectional matrix (in other words a matrix with one line or strip).

Therefore, in this figure a strip 60 is shown by way of example having four sources (for example a strip with four single-bar diodes) which transmit a light signals 61, 62, 63, 64 respectively. The signals can have the same or different wavelengths. Each of these signals passes through collimation means (collimator) 65 consisting, for example, of a strip of four micro-lenses. The signals, then, pass through a strip 67 of four active coupling devices according to an embodiment of the invention which transmits four light waves 71, 72, 73 74 either single-mode or slightly multimode at wavelengths respectively compatible with four input guides 81, 82, 83, 84 of one same component 90 or of different components. A second collimation means (collimator) 69 consisting, for example, of a strip of four micro-lenses is arranged along the pathway of the light waves between the strip of coupling devices and the input of the guides.

Strip 67 of active devices comprises either four individual active devices placed end to end, each of these devices being able to receive one of the signals and to emit a light wave, or by a single structure of appropriate size so as to be equivalent to four superimposed zones, each zone corresponding to an active device and able to receive one of the signals and to emit a light wave.

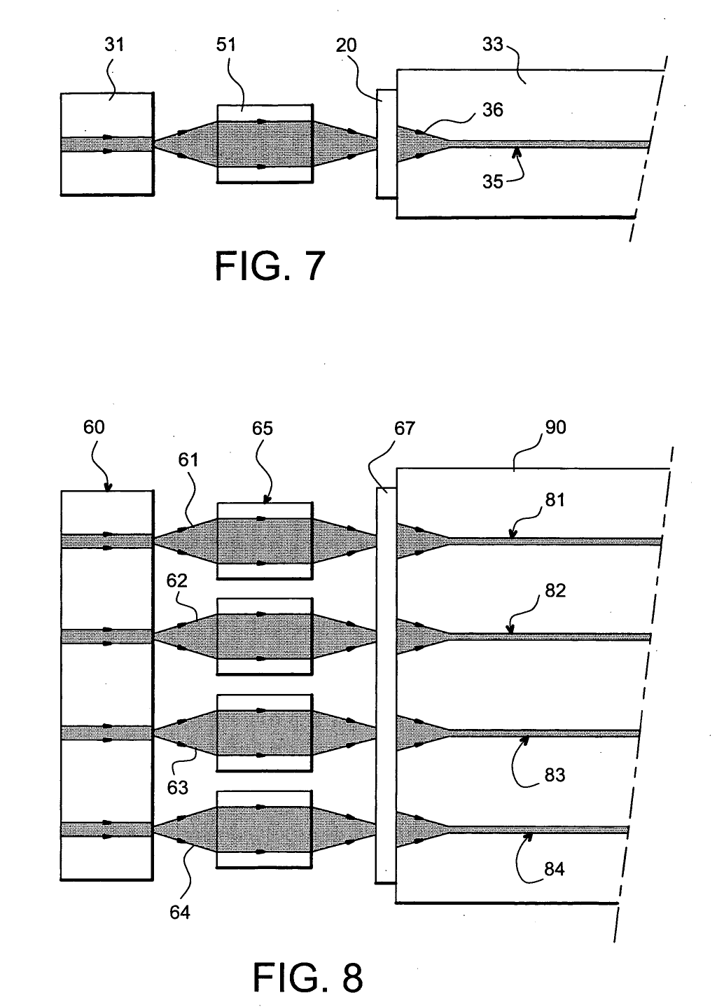

According to one embodiment, illustrated in FIG. 7, active coupling device 20 is arranged directly at the input of waveguide 35 using any conventional assembly technique, bonding for example. This embodiment does not use second collimation means (collimator). The light wave emitted by the coupling device generally has low divergence (the diameter of this wave typically ranges from 50 μm to 100 μm for a laser cavity such as described with reference to FIG. 3). The light wave is coupled directly into the guide. This coupling is facilitated by the presence of a taper 36. The taper 36 preferably has a diameter of the same order of magnitude as that of the light wave.

Finally, FIG. 8 schematically illustrates a variant of the embodiment shown in FIG. 7 applied to a matrix structure which is unidirectional in the case shown, as in the example illustrated in FIG. 6.

This figure shows the same parts as in FIG. 6 except that the strip of coupling devices 67 is arranged directly on component 90 so that the light waves emitted by the coupling devices penetrate directly into the input guides associated with these waves.

The invention applies to optical components of all types and more particularly to active components.

For example, in the application of an embodiment of the invention to a structure comprising an amplifier as optical component, for example an amplifier optically integrated on glass such as the one known as EDWA fabricated on Er-doped phosphate glass, for the amplification of telecommunications signals in the region of 1.5 μm and comprising an input guide (single mode or with a few modes) having a typical diameter of a few μm, it is possible to choose an active coupling device.

The active coupling may include, for example, a planar-planar laser cavity such as described in FIG. 2 emitting a wavelength ranging from approximately 1530 nm to 1550 nm and a source such as a wide-bar pump laser diode (bar width 50-250 μm, typically 100 μm) and highly transverse multimode. This type of source emits at 975-980 nm for example and at a relatively high power, between 100 mW and several watts, typically from 500 mW to 1 W. The beam emitted by such a source is multimode (several hundred transverse modes) and highly divergent 30-40 half-angle degrees. The beam is then focused according to any embodiment of the invention using first collimation means (collimator), for example a lens with index gradient, on the input surface of the laser cavity. The material in the laser cavity then absorbs the power of the laser diode and emits a laser beam at a longer wavelength (e.g. 1550 nm), transverse single-mode TEM 00 close to the quality of a Gaussian beam perfectly limited by diffraction or with only a few transverse modes (TEM mn where m and n<5).

In addition, the beam emitted by the coupling device is only slightly divergent with typical divergence of between 5-25 mrad (i.e. a half-angle of 0.3 to 1.5 degrees). The beam can be easily focused on a small spot (a few μm in diameter) by second collimation means, for example with a mini-lens so as to be very efficiently coupled (efficacy of more than 70 to 90%) in the input guide of the component.

The above example clearly shows the advantage of the invention concerning the transformation of wavelength. With amplifiers having a waveguide intended to work in the L-band of optical telecommunications (1570 to 1620 nm), it can be advantageous to pump the amplifier at a wavelength ranging from approximately 1530 nm to 1550 nm (λ₂) rather than at 980 nm (λ₁) delivered by the pump laser diode. The quantitative yield is almost two times higher (1550/980). In addition the amplifier will generate less spontaneous emission that is extremely harmful in the noise factor of the amplifier.

Furthermore, another advantage of the invention concerning mode reduction is also illustrated in the above example. A high power pump beam with poor quality (multimode and divergent) is transformed into an almost perfect beam (single-mode or with only a few modes, low divergence) which allows highly efficient coupling in the single-mode or low-multimode guide of the component with waveguide.

Another example of application of an embodiment of the invention to a structure comprising an integrated optical amplifier as an optical component, fabricated on Tm³⁺ doped materials, such as TDFA type amplifiers (Thullium Doped Fiber Amplifier) using fluoride materials, for example. Such TDFA amplifiers can be used to amplify telecommunications signals in the S-band between 1450 nm and 1520 nm.

The amplifier comprises an input guide (single-mode or with a few modes) of typical diameter a few μm. In this structure comprising an integrated optical amplifier, it is possible to choose an active coupling device, for example, a planar-planar laser cavity as described in FIG. 2, emitting around 1050 nm with an active material such as Nd³⁺ doped YLF, and a source such as a wide-bar pump laser diode (bar width 50-250 μm, typically 100 μm) and highly transverse multimode. This type of source emits around 800 nm, for example, and has a relatively high power, between 100 mW and several watts, typically from 500 mW to 1 W. The beam emitted by the source is multimode (several hundred transverse modes) and highly divergent (30-40 half-angle degrees). The beam is then focused according to an embodiment of the invention using first collimation means (for example a lens with index gradient) on the input surface of the laser cavity in Nd³⁺ doped YLF which then absorbs the power of the laser diode and emits a laser beam at a longer wavelength (for example around 1050 nm), transverse single mode TEM 00 close to the quality of a Gaussian beam perfectly limited by diffraction or with only a few transverse modes (TEM mn with m and n<5). The beam emitted by the coupling device is only slightly divergent, with typical divergence of between 5-25 mrad (i.e. a half angle of 0.3 to 1.5 degrees). The beam may also be easily focused on a small spot (a few μm in diameter) by a second collimation means (collimator), for example, with a mini-lens so as to be very efficiently coupled (efficacy of over 70 to 90%) in the input guide of the component.

The above example shows that an embodiment of the invention is particularly well suited for wavelength transformation. For Tm amplifiers with waveguide intended to operate in the S-band of optical telecommunications (1450 nm and 1520 nm) the amplifier needs to be pumped in the region of 1050 nm (λ₂) which is absorbed by the Tm³⁺ ions. This wavelength is not delivered by conventional pump laser diodes that are commercially available. On the other hand, with conventional laser diodes which emit at around 800 nm, it is possible to pump Nd-doped YLF material emitting at around 1050 nm.

Although the active coupler of the present invention is shown in various specific embodiments, one of ordinary skill in the art would appreciate that variations to these embodiments can be made therein without departing from the spirit and scope of the present invention. Accordingly, all suitable modifications and equivalents should be considered as falling within the spirit and scope of the invention.

1. An active coupling device comprising:
an input port and an output port,
wherein a first light signal having a first range of wavelengths is input through the input port and a second light signal having a second range of wavelengths is emitted through the output port,
said second light signal is coupled to an optical component comprising an input waveguide associated with a third range of wavelengths, and
said second range of wavelengths lies at least in part in said third range of wavelengths.

2. An active coupling device as in claim 1, wherein the optical component has a desired optical characteristic within the third range of wavelengths.

3. An active coupling device as in claim 2, wherein the desired optical characteristic is selected from the group comprising amplification, absorption, fluorescence, phosphorescence, diffraction, refraction, reflection, transparency, dispersion, diffusion, frequency conversion and spectrum inversion.

4. An active coupling device as in claim 1, wherein the second light signal has a mode profile adapted to a mode profile of said an input waveguide.

5. An active coupling device as in claim 4, wherein the first light signal is multimode, the mode profile of the at least one input waveguide is one of a single-mode and low multimode, and the second signal is one of a single-mode and low multimode.

6. An active coupling device as in claim 1, further comprising:
a first reflector and a second reflector,
wherein said first reflector and said second reflector form a laser cavity.

7. An active coupling device as in claim 6, further comprising:
a laser material disposed between said first reflector and said second reflector inside said laser cavity,
wherein said laser material comprises a material doped with active ions.

8. An active coupling device as in claim 7, wherein said first reflector includes at least one of a planar mirror, a concave mirror and a network of micro-mirrors.

9. An active coupling device as in claim 7, wherein said second reflector includes at least one of a planar mirror, a concave mirror and a network of micro-mirrors.

10. An active coupling device as in claim 7, wherein the laser material is selected from the group consisting of: oxide materials, fluoride materials, phosphate materials, silicate materials, tungstate materials, molybdate materials, vanadate materials, beryylate materials, phosphate glasses, silicate glasses, and a combination thereof.

11. An active coupling device as in claim 7, wherein the active ions are selected from the group consisting of: rare earths, transition metals, actinides, and a combination thereof.

12. An active coupling device as in claim 8, wherein said first reflector comprises dielectric multilayers.

13. An active coupling device as in claim 12, wherein said dielectric multilayers are alternate layers of SiO₂ and TiO₂.

14. An active coupling device as in claim 9, wherein said second reflector comprises dielectric multilayers.

15. An active coupling device as in claim 14, wherein said dielectric multilayers are alternate layers of SiO₂ and TiO₂.

16. An active coupling device as in claim 10, wherein the laser material is doped or co-doped with Er³⁺ and/or Yb³⁺ rare earth ions.

17. An optical structure comprising:
a light source, said light source emitting a first light signal;
an optical component comprising an input waveguide; and
an active coupling device, inserted between said source and said input waveguide, said active coupling device comprising:
an input port and an output port,
wherein the first light signal emitted by said light source and having a first range of wavelengths is input through the input port and a second light signal having a second range of wavelengths is emitted through the output port,
said second light signal is coupled to the optical component comprising said input waveguide, said input waveguide is associated with a third range of wavelengths, and
said second range of wavelengths lies at least in part in said third range of wavelengths.

18. An optical structure as in claim 17, wherein the input waveguide is tapered.

19. An optical structure as in claim 17, further comprising a first collimator, said first collimator disposed between the light source and the coupling device.

20. An optical structure as in claim 17, further comprising a second collimator arranged between the coupling device and the waveguide.

21. An optical structure as in claim 17, wherein the coupling device is positioned directly at the input of the waveguide.

22. Optical structure as in claim 17, wherein the source is selected from the group consisting of a pumping source and an optical element able to emit the light signal.

23. Optical structure as in claim 17, wherein the optical element is selected from the group consisting of an optical amplifier, a spectrum inverter and a frequency converter.

24. An optical structure comprising:
a first light source, said first light source emitting a first light signal;
a second light source, said second light source emitting a second light signal;
an optical component comprising a first input waveguide and a second input waveguide;
an active coupling device arranged between the first source and the first guide, the active coupling device comprising:
an input port and output port,
wherein the first light signal emitted by the first light source and having a first range of wavelengths is input through the input port and a first output light signal having a second range of wavelengths is emitted through the output port, said output light signal is coupled to the first optical component comprising the first input waveguide, the input waveguide is associated with a third range of wavelengths, and the second range of wavelengths lies at least in part in said third range of wavelengths.

25. An optical structure as in claim 24, further comprising:
another active coupling device arranged between the second source and the second guide, said another active device is configured to receive the second light signal and to emit a second output light signal.

26. An optical structure comprising:
a plurality of light sources;
an optical component comprising a plurality of input waveguides;
a plurality of active coupling devices arranged between the plurality of sources and the plurality of input waveguides, each of said plurality of active coupling devices comprises:
an input port and output port,
wherein a first light signal having a first range of wavelengths is emitted by a first light source in said plurality of light sources and is input through the input port and a first output light signal having a second range of wavelengths is emitted through the output port, said output light signal is coupled to the optical component comprising the plurality of input waveguides, at least one input waveguide in said plurality of input waveguides is associated with a third range of wavelengths, and the second range of wavelengths lies at least in part in said third range of wavelengths.

27. An optical structure as in claim 26, wherein said plurality of light sources is a matrix of n×m light sources, said plurality of active coupling devices is a matrix of n×m active coupling devices, said plurality of input waveguides is a matrix of n×m input waveguides, where n and m are integer numbers.

28. An optical structure as in claim 26, further comprising:
a first plurality of collimators disposed between the plurality of light sources and the plurality of active coupling devices.

29. An optical structure as in claim 26, further comprising:
a second plurality of collimators disposed between the plurality of active coupling devices and the plurality of input waveguides.
